(19) United States
(12) Patent Application Publication
(10) Pub. No.: US 2011/0274505 A1
(43) Pub. Date: Nov. 10, 2011

(54) SEALED PNEUMATIC CARRIER WITH SLAM-LATCH

(76) Inventors: Kenneth Michael Hoganson, Aurora, CO (US); Raymond Anthony Castro, Denver, CO (US)

(21) Appl. No.: 12/774,366

(22) Filed: May 5, 2010

(51) Int. Cl. B65G 51/06

(52) U.S. Cl. 406/190

(57) ABSTRACT

Provided herein is a pneumatic carrier having a leak resistant cargo area where first and second mating shells form the carrier. To provide a leak resistant cargo area, the one embodiment of the carrier employs a tongue and groove sealing arrangement. In this arrangement, an engagement surface about a peripheral edge of one of the shells includes a tapered groove and the engagement surface around the engagement surface of the other shell includes a protruding tongue member. A sealing element is disposed over the tongue or lines the groove. When the first and second shell members are joined together, the sealing member provides a substantially fluid-tight seal between the first and second shell members.

### FIELD

The present disclosure relates to carrier vessels for use with pneumatic tube transport systems. More particularly, aspects of the present disclosure relate to a two-part carrier vessel having single stage to close latch and seal arrangement that provides a substantially leak-proof connection between contacting surfaces of the carrier vessel when the vessel is closed.

### BACKGROUND

Many buildings or structures include pneumatic tube transport systems for transporting objects, such as products, components, documents, drawings or other materials from one location in the building to another. Pneumatic tube transport systems typically comprise a number of substantially hermetically sealed tubes extending between locations in a building and a mechanism for selectively evacuating air from, or forcing air into, the tubes. In use, objects are placed in a carrier vessel, typically a substantially cylindrical housing, which is placed into the pneumatic tube transport system. The vessel is then propelled through the tube by creating a zone of relatively higher pressure on one side of the carrier vessel than on the other. This may be accomplished by creating a zone of negative pressure (e.g. a vacuum) in front of the vessel or by creating a zone of positive pressure behind the vessel.

In certain settings, objects housing fluids need to be transported using the pneumatic tube transport system. For example, in the health care setting pneumatic tube transport systems are well adapted for transporting fluids such as laboratory samples, blood samples or other body fluids, or intravenous bags between areas of the building. When using pneumatic tube transport systems in such health care applications, it is desirable that the carrier vessels be suitable for transporting fluids. More particularly, it is desirable that the carrier vessels, upon closure, seal to provide substantially leak-resistant containment of fluids, which may unwontedly spill from their primary containers into the vessel. Fluids which spill from their primary containers inside the vessel may leak from the vessel into the pneumatic tube posing a health risk and resulting in a risk that the pneumatic tubes may not properly function due to the presence of fluid in the system.

Various attempts have been made to produce leak-proof or sealing pneumatic carriers. However, such carriers have suffered from various drawbacks. For instance, many prior sealing carriers have utilized a flat gasket or O-ring that forms a seal, upon compression between mating surfaces of the opposing shells of the pneumatic carrier. However, such gaskets or O-rings typically require a significant compressive force to achieve a leak-proof seal (i.e., energize the seal).

To achieve compressive forces to effectively energize the seal, prior carriers have typically utilized multi-stage latches. Such latches typically require a user to close the carrier, hook the latch, and subsequently engage the latch to further compress the gasket or O-ring. That is, the act of closing the carrier does not, by itself, form a seal. The user must 1) close the carrier and 2) latch the carrier using, for example three-bar latch arrangements and/or sliding cam latch arrangements that provide the mechanical force multiplication necessary to energize the seal.

### SUMMARY

The present inventors have recognized that prior art sealing carriers often provide an ineffective seal. One specific area of seal failure is user operation. That is, users often fail to adequately fully engage the latch after closing the carrier. Stated otherwise, users are often distracted or in a hurry and fail to perform or fully perform the second stage latching (e.g., compression step) required to form an effective seal.

Accordingly, provided herein are various carrier sealing arrangements that allow for generating an effective seal in the presence of reduced compressive forces, providing multiple sealing surfaces on a single sealing element and/or provide single-stage closing and sealing of a pneumatic carrier. Such various aspects of the presented inventions are considered novel alone and/or in various combinations.

To accomplish the aforementioned and other objectives, one aspect of the presented inventions is directed to a carrier that employs a raised seal arrangement. The carrier includes first and second shell members, each having an opposing engagement surface. A sealing periphery extends about a portion or all of the engagement surface of each respective shell. A sealing element is disposed on one of the sealing peripheries. When the first and second shell members are joined together to form a carrier vessel, the sealing member provides a substantially fluid-tight seal between the first and second shell members. One engagement surface includes the sealing element, which protrudes above that engagement surface and extends about the sealing periphery of the shell, and the other engagement surface includes a tapered recess or groove that extends about its sealing periphery and receives the protruding sealing element when the shells close. Generally, the height of the sealing element is greater than the depth of the tapered groove. When the first and second shell members are engaged, such as by latching, to form a closed carrier vessel, the sealing element is disposed in the tapered groove, which compresses the end and/or side surfaces of the sealing element, to establish a leak-resistant seal between the first and second shell members. The carrier vessel thus provides leak-resistant containment of fluids which may spill from their primary containers into the carrier vessel.

The use of the tapered groove in combination with the protruding seal element, which has a height that is greater than the depth of the groove, allows for compressing a tip portion of the sealing element without requiring substantial compressive forces between the first and second shells. In one arrangement, the tip of the sealing element contacts a bottom or floor surface of the tapered groove prior to the shells being completely closed. Additional closure of the shells results in the tip portion deflecting/compressing and filling the bottom of the tapered groove to provide an effective seal between the engagement surfaces.

In one arrangement, the tapered groove includes first and second angled or slanting side walls (e.g., in relation to a plane defined by the sealing periphery and/or engagement surface). That is, the sidewalls a non-parallel.

In one arrangement, the protruding seal element is tapered between its base and its tip. In such an arrangement, the seal element may have first and second slanting side walls, which like the tapered groove are non- parallel. It will be appreciated that the angles of such a tapered sealing element and the tapered groove may be equal in various arrangements and different in other arrangements. In one arrangement, the tip of the sealing element has a width that is greater than the corresponding width of a bottom surface of the tapered groove. In one particular arrangement, the tip of the sealing element is bulbed. In such an arrangement the bulbed tip may be axially compressed between the engagement surfaces as well as being compressed by side surfaces of the tapered groove.

In one arrangement, the protruding seal element further includes one or more lips that may extend around its periphery. Such lips may be formed on one or more side surfaces of the protruding sealing element. In such an arrangement, a cross-dimension of the sealing element measured through the lip may be greater than a corresponding cross-dimension of the tapered groove. In such an arrangement, the lip(s) may contact a side wall of the tapered groove and may be compressed by the sidewall of the tapered groove.

The sealing element may be formed of any material that provides desired compression and/or non-permeability. Such materials include, without limitations, elastomateric materials, natural rubbers, foams etc. Generally, any material that, when compressed in one direction flows in another, may be utilized. In any arrangement, it may be desirable that the seal element has a hardness that allows for creating a seal upon compression. In one arrangement, the sealing element has a durometer hardness between about 35 Shore A and about 50 Shore D. In various arrangements, a soft sealing element may be disposed within a more durable casing. By way of example only, a porous foam sealing element may be cased in a thin layer of plastic to provide non-porosity and/or a more durable surface. In the latter regard, a thin coating may be applied to improve wear characteristics of the sealing element.

According to another aspect of the presented inventions, a pneumatic carrier is provided that allows for generating multiple sealing surfaces on a single sealing element. The carrier includes the first shell having a first engagement surface that includes a tapered groove extending about a periphery thereof and a second shell having a second engagement surface that includes a protruding tongue extending about a periphery thereof. A compressible sealing element is disposed over an outside surface of the protruding tongue or lines the inside surface of the groove. A hinge member couples the first and second shells and permits movement of these shells between a closed position and an open position. In the closed position, the tongue is disposed in the tapered groove. The tongue and the tapered groove collectively compress multiple sections of the sealing element. That is, a first set of mating surfaces of the tapered groove and tongue compress a first portion of the sealing element and a second set of mating surfaces of the tapered groove and tongue compress a second portion of the sealing element. In this regard, a single sealing element may provide multiple seals. The carrier further includes a latch of having a first portion attached to one of the shells that is adapted to engage the other shell in order to secure the shells in the closed position.

In one arrangement, the first and second portions of the seal are compressed along first and second different lines of compression. Such lines of compression are, in one arrangement, transverse. For instance, in one arrangement the first line of compression may be an axial line compression between a tip of the protruding tongue and a bottom surface of the tapered groove. That is, the tip surface of the tongue and the bottom surface of the tapered groove may define a first set of mating surfaces. A second set of mating surfaces may be defined by a side surface of the tapered groove and a side surface of the protruding tongue. In one arrangement, these side surfaces may both be tapered such that, in a closed position, a portion of the sealing element compressed between these side surfaces experiences a compression force in a direction normal to the tapered side surfaces of the groove and/or tongue.

In one arrangement, the sealing element is over-molded over the outside surface of the protruding tongue. In another arrangement, the sealing element is separately formed and attached to the protruding tongue such that it covers at least the tip of the tongue and one or more side surfaces thereof. In another arrangement, the sealing element lines inside surfaces of the groove.

According to another aspect of the presented inventions, a single-stage to close sealing carrier is provided. In this aspect, the act of closing the carrier energizes the seal between first and second shell members. That is, no secondary compression force is required to further compress the seal after initial closure. The carrier includes a first shell having a first engagement surface with the tapered groove extending around a periphery thereof and a second shell having a second engagement surface with a protruding tongue extending around a periphery thereof. A sealing element is either disposed over an outside surface of the protruding tongue or lines an inside surface of the tapered groove. A hinge member interconnects the first and second shells permit movement between a closed position and an open position. The sealing element and the tongue are disposed within the tapered groove in the closed position and the sealing element is at least partially compressed. A latch interconnects the first and second shells. The latch includes a biased pawl member that is attached to one of the first and second shells and a detent formed in the other of the first and second shells. The detent receives the pawl as the shells move from the open position to the closed position. Upon the detent receiving the pawl, the carrier is closed and the seal element is energized to form a fluid-tight seal around the peripheries of the engagement surfaces.

The latch may be any mechanism that allows for attaching the first and second shells in conjunction with movement from a first position to a second position where no secondary user engagement is required. In one arrangement, the biased pawl member includes a sliding element and a spring. In this arrangement, the sliding element may compress the spring as the sliding element retracts from the first position to the second position. For instance, a tip of the sliding element may engage a ramped surface (or other angled surface) associated with the detent. That is, the sliding element may automatically retract until it reaches the top of such a ramped surface at which time it may be biased into the detent by the spring.

Various methods are also provided in conjunction with the presented inventions. In one aspect, such method includes disposing a tongue member that extends around a periphery of an engagement surface of a first carrier shell into a tapered groove that extends around a periphery of an engagement surface of a second carrier shell. Such disposition allows for compressing first and second portions of the sealing element between tongue member and the tapered groove to provide a multi-surface seal between the carrier shells. That is, such functionality allows for generating multiple seal surfaces on a single sealing element. In conjunction with such compressing, a biased pawl member attached to one of the carrier shells may engage a recess or detent in the other of the carrier shells to secure the shells in a closed position while energizing the seal element.

Additional advantages of the present invention will become readily apparent from the following discussion, particularly when taken together with the accompanying drawings.

### BRIEF DESCRIPTION OF THE DRAWINGS

FIG. 1 is a perspective view of one embodiment of a carrier vessel when closed.;

FIGS. 2A and 2B show perspective and plan views, respectively, of one embodiment of a carrier vessel when opened;

FIG. 3 is an enlarged cross-sectional view of one embodiment of a sealing element and engagement surfaces of the first and second carrier shells, prior to closing;

FIG. 4 is an enlarged cross-sectional view of one embodiment of the sealing element and engagement surfaces of the first and second carrier shells, after closing;

FIGS. 5A-5C are enlarged cross-sectional views of another embodiment a sealing element and engagement surfaces, before, during and after closing the first and second shell members of the carrier vessel;

FIGS. 6A-6C are enlarged cross-sectional views of another embodiment a sealing element and engagement surfaces, before, during and after closing the first and second shell members of the carrier vessel;

FIGS. 7A-7C illustrate one, non-limiting, embodiment of a single-stage latch that allows for energizing a seal between the first and second shells of the carrier vessel in conjunction with closing the carrier vessel.

### DETAILED DESCRIPTION

Reference will now be made to the accompanying drawings, which assist in illustrating the various pertinent features of the present disclosure. Although the present disclosure is described primarily in conjunction with a side-opening carrier for use in a pneumatic tube transport system, it should be expressly understood that aspects of the present invention may be applicable to other carrier configuration including, without limitation, end-opening carriers. In this regard, the following description is presented for purposes of illustration and description.

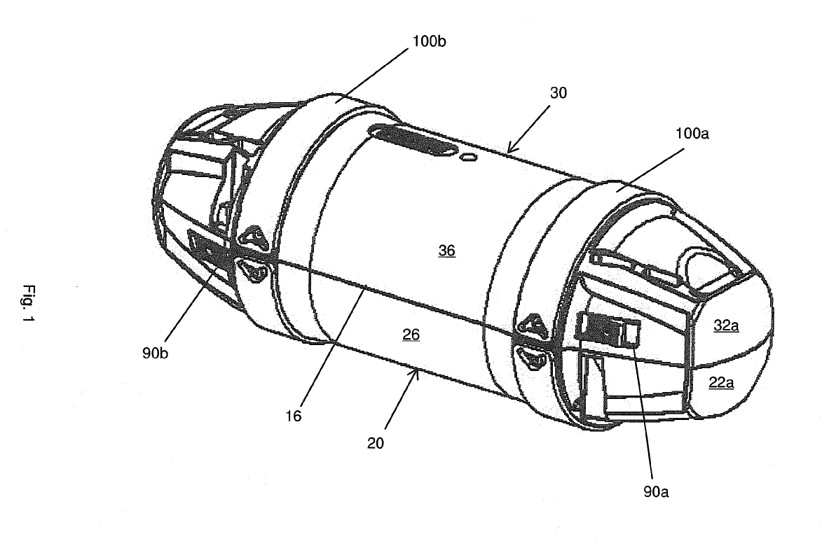

FIGS. 1,2A and 2B illustrate one embodiment of a carrier 10, which may be used to house objects being transported in a pneumatic tube transport system. The carrier 10 includes a first shell member 20 and a second shell member 30 engageable along opposing engagement surfaces that at least partially define an interface 16 when the shell members are engaged to form a substantially cylindrical carrier vessel. Advantageously, when the first shell 20 and second shell 30 are secured, a substantially fluid-tight seal is formed between the two shell members to inhibit the passage of fluids into or out of the carrier 10. Accordingly, the carrier 10 may be used to transport containers that include fluids in a pneumatic tube transport system, with reduced concern of these fluids spilling.

The first shell member 20 includes first and second end walls 22a, 22b. A semi-cylindrical housing wall 26 extends between the first and second end walls 22a, 22b. The edges of the end walls 22a, 22b and housing wall 26 define a first engagement surface 40, which extends substantially in a single plane about the perimeter of the first shell member 20. Second shell member 30 is similar in shape to the first shell member 20 and includes first and second end walls 32a, 32b and a semi-cylindrical housing wall 36. The edges of the end walls 32a, 32b and housing wall 36 define a second engagement surface 50 which extends substantially in a single plane about the perimeter of the second shell member 30. Shell members 20, 30 are in one embodiment formed from a translucent, rigid plastic material, however it will be appreciated that numerous other materials, including opaque materials, metals or carbon composite materials, could be used.

When the first and second engagement surfaces 40, 50 are juxtaposed (i.e., the carrier is closed) the carrier defines a generally cylindrical vessel having an enclosed interior. In the present embodiment, first and second ends of the carrier are tapered or frustoconical. However, it will be appreciated that other embodiments may utilize different configurations.

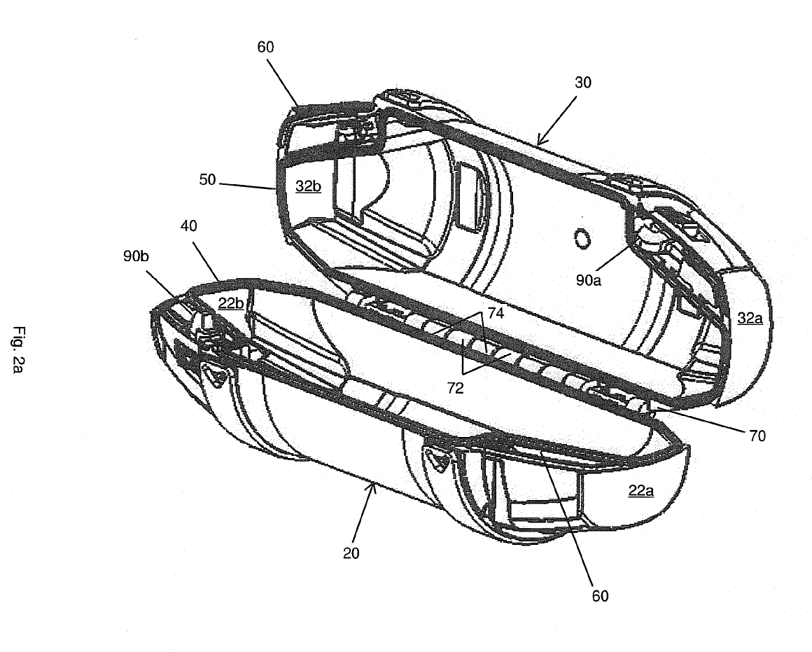

A hinge assembly 70 joins the first and second shell members 20, 30 together to permit pivotal movement therebetween. The hinge assembly 70 includes first and second sets of ferrules 72, 74 that are attached along a lateral edge of the first and second shells 20, 30. Each set of ferrules are spaced longitudinally along their respective housing wall 26 or 36 for alternating engagement with the ferrules on the opposing shell. In the present embodiment, these ferrules are an integral part of the shell members 20, 30. It will be appreciated that more ferrules could be used or that such ferrules could be formed separately and secured to shell members 20, 30 using conventional fasteners. As seen in FIG. 2B, a hinge pin 76 is disposed through the inside of the ferrules 72, 74 to ensure that the shell members 20, 30 are aligned and allow movement between an open position and a closed position. The carrier 10 also includes wear bands 100 for positioning the carrier within tubes of the pneumatic tube system and for creating a seal across the carrier when positioned within such tubes. As illustrated in FIG. 1 identical first and second sets of wear bands 100a, 100b are attached to the first shell member 20 and the second shell member 30.

As illustrated in FIGS. 2A and 2B, first and second engagement surfaces 40, 50 extend generally around the periphery of the first and second shells 20, 30, respectively. However, in the present embodiment, the latching assemblies as well as the hinge assembly 70 are disposed outside of the periphery defined by these engagement surfaces 40, 50. That is, the engagement surface do not exactly match the outside periphery of each shell. Rather the engagement surfaces are disposed in-board of the latch assemblies 90a, 90b and the hinge assembly 70. As will be appreciated, this eliminates the need to seal around these assemblies. Stated otherwise, the periphery of the sealed enclosure defined by the engagement surfaces is free of intrusion by the hinge assembly 70 and/or the latch assemblies 90. However, it will be appreciated that, in other embodiments, one or more of these assemblies may be disposed within the periphery of the seal element. For instance, U.S. Pat. No. 5,655,677 to Fratello discloses an arrangement where the hinge assembly may be disposed within the perimeter of a sealing surface.

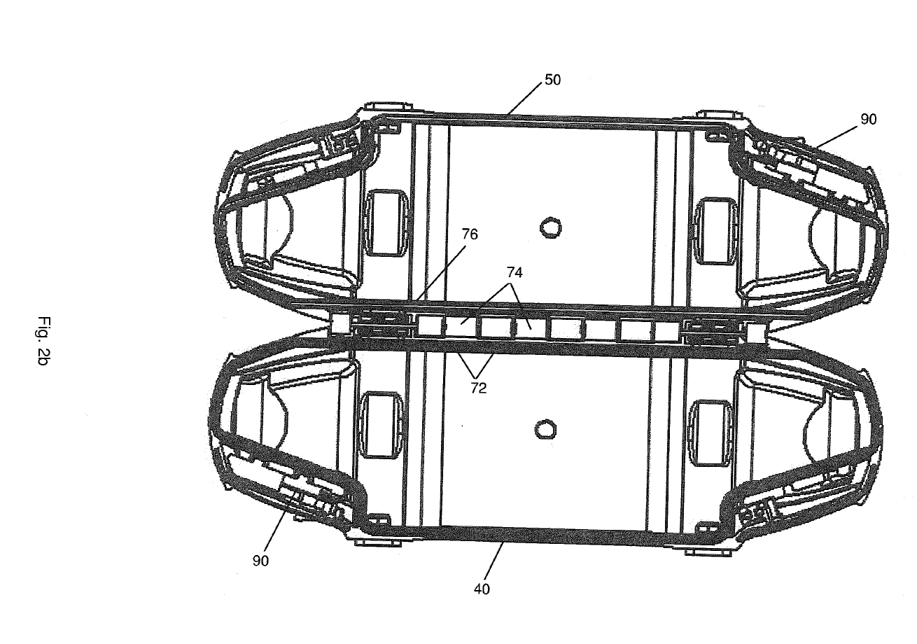

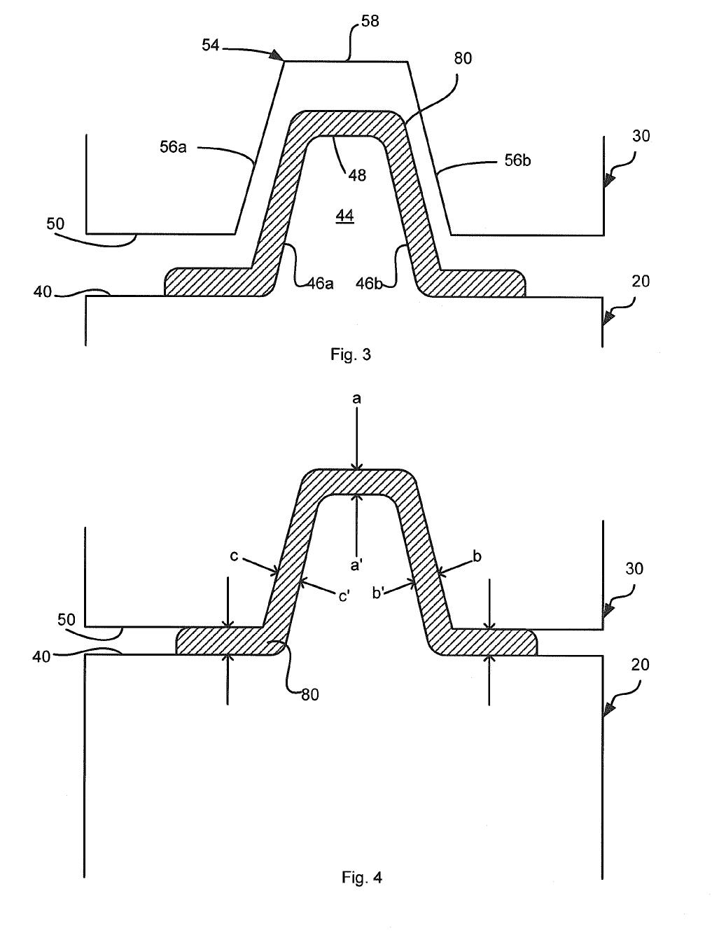

One feature of the presented carrier relates to the substantially fluid tight seal formed between first engagement surface 40 and second engagement surface 50 when the carrier 10 is closed. As shown in FIGS. 2B and 3, the first engagement surface 40 includes a protruding seal element that is disposed around its periphery and the second engagement surface 50 includes a groove 54 that is disposed about its periphery. That is, the presented carrier utilizes a first engagement surface 40 having a protruding seal element 80 that is sized for receipt within a recessed groove 54 formed around the periphery of the opposing engagement surface 50. In the present arrangement, the protruding seal element 80 is disposed over a tongue member 44 that is attached to or integrally formed about the periphery of the first engagement surface. This tongue member 44 provides internal rigidity for the sealing element 80 and, in some embodiments, facilitates compression of the sealing element 80. However, it will be appreciated that various embodiments of the presented carrier need not include the tongue member of the second engagement surface. That is, a protruding seal element may be attached to the engagement surface free of the tongue member. In other embodiments, the recessed groove may be lined with a seal element and the lined groove may receive a protruding tongue member. However, in the primary embodiments discussed herein, a sealing element 80 is disposed over a tongue member 44 that is formed around the second engagement surface 40.

FIGS. 3 and 4 illustrate a cross-sectional view of a portion of the engagement surfaces 40, 50 and the sealing element 80. In the illustrated embodiment, the tongue member 44 is integrally formed with the first engagement surface 40. In this embodiment, the sealing element 80 is over molded over the tongue member 44. However, it will be appreciated that in other embodiments the sealing element may be separately formed and disposed over the tongue member 44 and/or disposed into the groove 54 formed into the opposing engagement surface 50. Sealing element 80 may be formed from any number of conventional sealing materials, including, without limitation, rubber or synthetic polymers and/or closed or open cell foams. In one embodiment, the sealing element has a minimum thickness of about 0.5 mm. The sealing element also has a durometer reading in the range between about 35 Shore A and about 50 Shore D. When softer materials form the sealing element, it may be desirable to encase the soft sealing element in a more durable outer coating. For instance, encasing a soft rubber seal in a thin plastic shell may improve the wear characteristics of the sealing element without altering its function. The casing may also improve the non-permeability of the sealing element thereby allowing use of preamble materials to form the sealing element.

As illustrated in FIGS. 1 and 4, when the first shell member 20 and the second shell member 30 are closed, the tongue member 44 and the overlying sealing element 80 are disposed into the groove 54. Generally, the height and/or width of the sealing element 80 is greater that the corresponding depth and/or width of the groove 54. Therefore, when first shell member 20 and second shell member 30 are securely latched in the closed position, the tongue member 44 and the tapered groove 54 compressively engage the sealing element 80 to form a substantially leak-proof seal about the cargo area of the carrier 10. This provides a carrier suitable for transporting fluids in a pneumatic tube transport system.

The presented tongue and groove arrangement provides a number of benefits to the presented carrier. Specifically, use of a tongue and groove sealing arrangement allows for generating multiple sealing surfaces on a single sealing element 80. As illustrated in FIG. 4, it is noted that when a portion of the tongue member 44 is received within the tapered groove 54 (i.e., when the shells are closed), the sealing element 80 is compressed between multiple faces of the tongue member 44 and the groove 54. More importantly, due to the various different face surfaces of the tongue 44 and groove 54, multiple separate compression locations are formed through the sealing member 80. In this regard, the sealing element 80 may form multiple seals between the first and second shell members.

Multiple sealing surfaces are especially beneficial in operation as the first and second shells 20, 30 are often not perfectly matched. That is, the shells 20, 30 do not necessarily form perfectly flat and level sealing surfaces. Generally, constructed of plastic materials, the shells are subject to manufacturing tolerances and variations, are not perfectly symmetric and can be slightly warped. In addition, the latches and hinges that are utilized to close the first and second shells, 20, 30 are usually positioned irregularly around the perimeter of the carrier. The result is the carrier body must be stiff enough to provide sufficient beam stiffness in areas remote from the latches and the hinge to successfully compress a seal. Typically, this results in the seal located near the latch being over compressed and areas removed from the latch or hinge being under compressed. This is particularly problematic when low modulus materials (such as polycarbonates) are utilized to manufacture pneumatic tube carriers. The physical material lacks sufficient stiffness to provide the beam rigidity necessary to compress the seals without creating excessively thick carrier shells or applying high compressive forces. Furthermore, as the carrier moves through a pneumatic tube system, the body defined by the first and second shells 20, 30 may become stressed, resulting in some deflection of one or both shells, which may allow for reducing compression on one or more portions of the sealing element which can result in leakage.

The present arrangement accounts for these irregularities in the manufacturing tolerances and lack of stiffness by providing multiple sealing surfaces of a single seal element. As illustrated in FIG. 4, when the first and second shells are in the closed position, multiple different portions of the sealing element are compressed. For instance, in the presented embodiment, the groove 54 is tapered and has first and second sidewalls 56a, 56b that are separated by a bottom surface 58. These sidewalls are typically non-parallel to provide multiple surfaces for compressing the seal element as discussed herein. In general, the groove 54 defined by the sidewalls 56 and bottom surface 58 extend below a base surface defined by the edges of the second engagement surface 50. As shown, the groove 54 is symmetric. However, it will be appreciated that in other embodiments the groove need not be symmetric.

The tongue member 44 is formed about the periphery of the first engagement surface 40. In the present embodiment, a base of the tongue member is integrally formed with the engagement surface. However, in other embodiments, the tongue may be separately interconnected to the engagement surface. As with the groove 54, the tongue member includes first and second slanting sidewalls (e.g., in relation to a base surface defined by the edges of the engagement surface 40) and a tip surface 48. Again, the tongue may be symmetric around its center or may be asymmetric. In one embodiment, the slanting sidewalls of the tongue 44 and groove 54 are substantially flat (e.g., planer) in cross-section and have an included angle (e.g., draft angle) that is typically less than about 90 degrees. However, other embodiments may utilize drat angles outside of this range. Further, it will be appreciated that, in different embodiments, the tongue member 44 and the groove 54 may have different included angles. Furthermore, the sidewalls of the tongue and/or groove need not necessarily be planar. For instance, the sidewalls of the tongue and/or groove may be bowed or otherwise shaped to enhance sealing.

In any arrangement, disposing the sealing element 80 over the tongue member 44 (or alternately overlaying the seal on the inside surfaces of the groove) allows for generating multiple lines of compression through the sealing element 80. As illustrated in FIG. 4, a first line of compression a-a¹ is formed through the sealing element 80 due to the compression between the tip 48 of the tongue member 54 and the bottom surface 58 of the groove 54. Likewise, compression of the sealing element between the corresponding side surfaces (e.g., 46a, 56a and 46b, 56b) of the tongue and groove provides two additional lines of compression b-b¹, c-c¹ through the sealing element 80. That is, the compression between these angled or slanted side surfaces results in a normal force that is substantially perpendicular to the surface of the seal.

These sets of corresponding side surfaces compress separate portions of sealing element 80 to generate second and/or third seal locations between the engagement surfaces. In this regard, multiple sealing surfaces may be generated utilizing a single sealing element. Furthermore, one or more portions of the sealing element 80 may be compressed between the planar surfaces of the first engagement surface 40 and the second engagement surface 50.

The generation of multiple sealing surfaces or lines of compression through a single sealing element, results in a carrier that is very resistant to leakage. For instance, if the carrier is dynamically stressed while passing through a tube transport system, such stress may act to reduce the sealing force through one line of compression. However, due to the multi-faced surfaces of the tongue 44 and groove 54, such stresses often correspondingly increase the sealing force on another line of compression. Therefore, if one sealing surface is compromised another sealing surface typically maintains the seal between the first and second shells.

The ability to generate multiple sealing surfaces on a single sealing element also allows for the carrier vessel to be closed with a reduced compression force while still generating a fluid tight seal. That is, the presented tongue and groove arrangement allows for energizing a seal between the first and second shells 20, 30 without utilizing a force multiplier. The redundancies of multiple sealing surfaces permits reducing the compression force necessary to generate a fluid tight seal especially in areas remote from the latches and the hinge. Accordingly, the act of moving the first and second shells 20, 30 from the open position to the closed position generates sufficient force to form an effective seal there between.

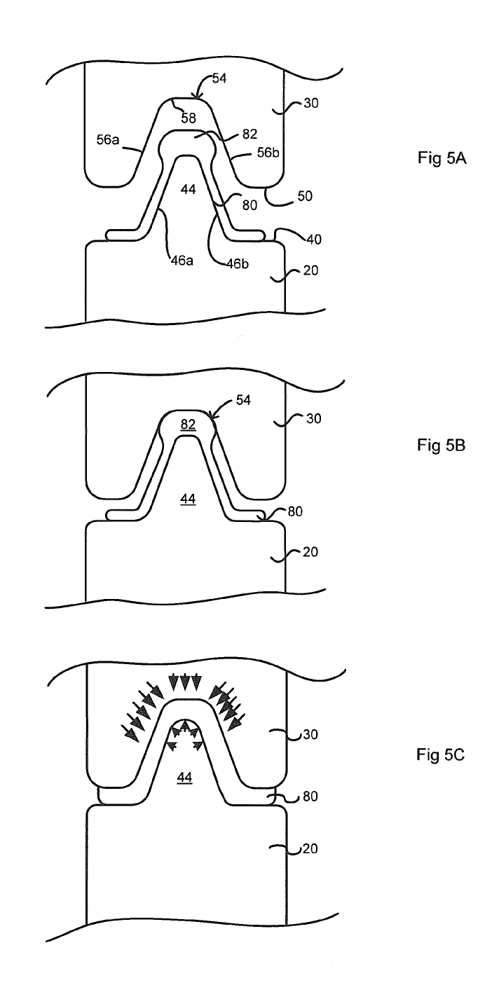

While illustrated in FIGS. 3 and 4 as having a generally uniform thickness, it will be appreciated that variation can be made to the sealing element as well. As illustrated in FIGS. 5A-5C, the thickness of the sealing element 80 is varied to enhance sealing. As illustrated in FIG. 5A, prior to compression, the sealing element 80 is again disposed over the outside surface of the tongue member 44. However, in this embodiment, the portion of the sealing element 80 disposed over the tip 48 of the tongue member 44 has a thickness that is greater than the thickness of the portion of the sealing element disposed over the side surfaces of the tongue member 54. In this particular embodiment, the tip portion 82 of the sealing element 80 is bulbed.

As illustrated in FIG. 5B, when the shells 20, 30 are closed, this bulbed portion 82 of the sealing element 80 initially contacts the tapered recess 54. In this regard, the bulbed portion 82 of the sealing element fills the bottom section of the tapered groove 54. As illustrated in FIG. 5C, this results in a sealing area having increased compression over and around the interface between the top portion of the tongue member 44 and the bottom portion of the tapered groove 54.

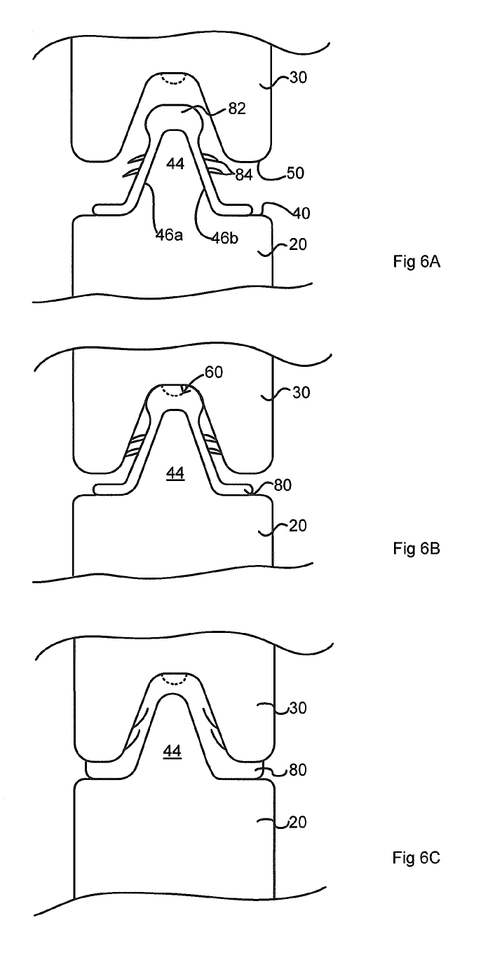

FIGS. 6A-6C illustrate a yet further embodiment of the sealing element 80. In this embodiment, in addition to having a bulbed tip portion 82, portions of the sealing element that extend over the side surfaces 46a, 46b of the tongue member 44 may further include one or more lips 84. These lips may be continuous around the periphery of the sealing element. In operation, these lips 84 allow for creating a further contact with the inside/side surfaces of the tapered groove 54. That is, as the engagement surfaces move to the closed position as illustrated in FIG. 6C, one or more of these lips 84 may engage the inside surface of the tapered groove 54 and be compressed against the seal element. It will be appreciated that such lips 84 may be utilized in conjunction with a bulbed tip portion 82 or without such a bulbed tip. In any arrangement, such lips may provide an improved seal between the shells while minimally increasing the force required to close the shells.

It will further be appreciated that the inside surface of the tapered groove 54 may likewise include one or more variations that allow for providing improved compression with the sealing element 80. For instance, a nub or rib 60 may be formed on a bottom surface of the tapered groove 54 to provide additional compression with the sealing element. Alternatively, a nub or rib may be formed on the tip of the tongue 44. Likewise, one or more nubs or ribs may be formed around the periphery of the side surfaces 56a, 56b of the tapered groove 54 or to the side surfaces of the tongue 44.

The latching or connecting mechanisms for releaseably holding the shell members 20, 30, together are next described in more detail. FIGS. 1, 2A and 7A-7C illustrate one non-limiting embodiment of a latching mechanism. As illustrated, these latching or connecting mechanisms comprise a pair of latch assemblies 90a, 90b that releasably attach the first and second shell member in the closed position. Each of the latch assemblies 90a, 90b (hereafter 90) includes a latch pawl 126 having a hooked tip. The latch assemblies also have an internal bias force member (e.g., spring coil, leaf spring, etc.) that permits linear movement of the pawl member 126 between a first position and a second position (e.g., an extended position and a retracted position). The latch pawl 126 and bias force member are connected to one of the shell members such that the hooked tip 130 may engage a detent on the other shell.

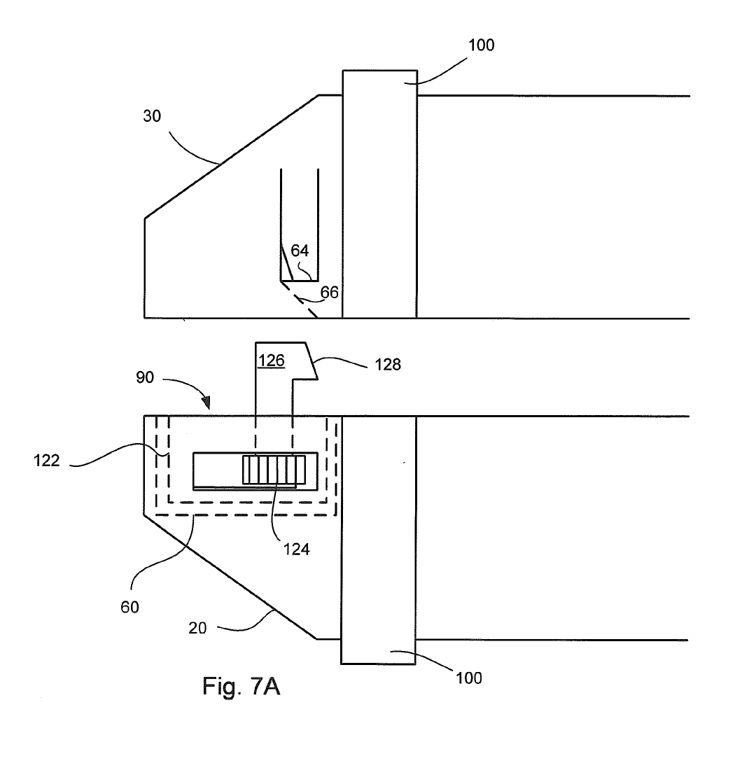

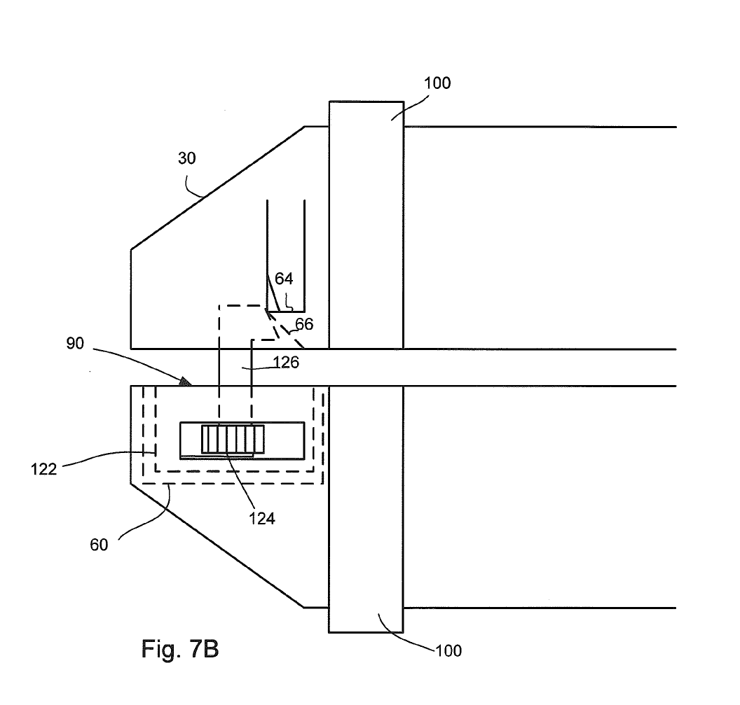

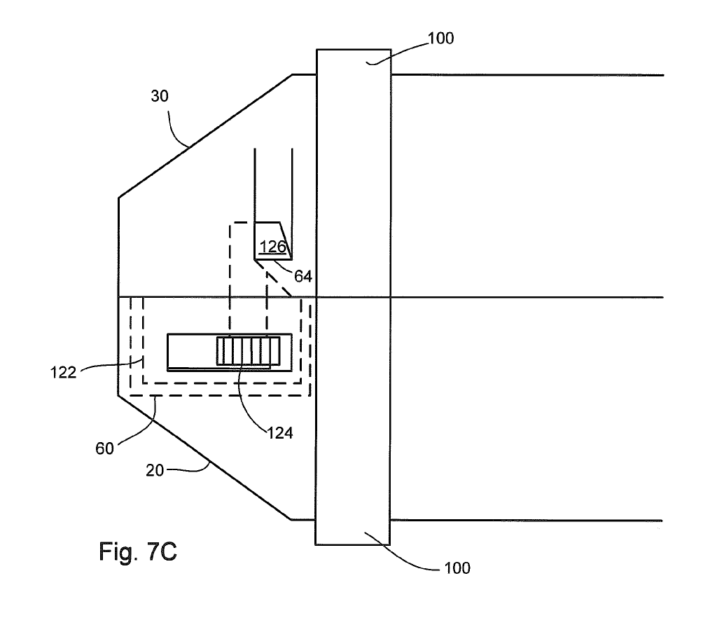

As better illustrated in FIGS. 2B and 7A-7C, the latch assemblies 90 are disposed within a receiving recess or pocket 60 formed in the front corner of the shell members 20, 30. As noted above, each latch assembly 90 is disposed outside of the periphery of the engagement surface 40 or 50 such that the latch assembly is outside the sealed cargo area formed by the engagement surfaces 40, 50 when the shells are closed. As shown, each latch assembly 90 includes a base member 122 that is disposed within the pocket 60 formed in the respective shell member. This base member 122 supports the latch pawl 126 as well as the bias force member. Once inserted within the pocket 60, a latch handle 124 is interconnected to the pawl 126. More specifically, the latch handle is disposed through an aperture formed in the housing wall 26. In the present embodiment, the latch handle may be secured to the pawl 126 utilizing a screw or other fastening means. Once so interconnected, the latch handle prevents the latch mechanism 90 from being removed from the pocket 60 within the shell member. As illustrated in FIGS. 7A-7C, the elongated aperture through the sidewall allows the latch handle to move forward and backward between an extended position (e.g., FIG. 7A) and retracted position (e.g., FIG. 7B). Likewise, movement of the latch handle allows for compressing the bias force member, thereby retracting the pawl 126.

The other shell member includes a detent 64 that is adapted to receive the hooked end of the pawl 126. Specifically, as shown in FIG. 7A, a top surface 128 of the pawl 126 is slanted and is adapted to engage a ramped surface 66 within the shell member 30 including the detent 66. When the first and second shell members are closed, the pawl is disposed in a pocket in opposing shell and the slanted top surface of the pawl 126 engages the ramped surface 66 of the detent 64, thereby compressing the bias force member and allowing the pawl 126 to automatically retract (See FIG. 7B). When the first and second shells are closed (See FIG. 7C), the hooked end of the pawl 126 falls over the top edge of the ramp 66 into the detent 64. This secures the first and second shells in the closed position. Accordingly, a user may open the shells by grasping the latch handles (e.g., with both thumbs on the first and second latching assemblies 90a, 90b) and retracting the pawls from the detents

Importantly, the relationship between the pawl 126 and the detent 64 is such that when the pawl 126 is engaged with the detent the sealing element 80 is energized. That is, the latch assembly 132 is a single stage latch where simply closing the shell members engages the latch and provides sufficient energizing force to form a seal between the first and second engagement surfaces. That is, a user is not required to provide additional compressive force after closing the first and second shells to energize the seal. Such a latch may be referred to as a single stage latch or a slam latch. Furthermore, due to the tapered contact between the groove 54 and the sealing member 80, in contrast to, for example, flat contact between two planar surfaces having a sealing member disposed therebetween, less force is required to engage the two shell members 20, 30 or open the carrier 10. This facilitates the opening and closing of the carrier 10.

The foregoing description of the present invention has been presented for purposes of illustration and description. Furthermore, the description is not intended to limit the inventions to the forms disclosed herein. Consequently, variations and modifications commensurate with the above teachings, and within the skill and knowledge of the relevant art, are part of the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

1. A pneumatic carrier for use in a pneumatic tube transport system, comprising:
first and second shells having first and second engagement surfaces, respectively, wherein the first and second engagement surfaces mate in a closed position to define an enclosed space;
a hinge member coupled to the first and second shells and permitting movement between the closed position and an open position;
a tapered groove that extends about a periphery of the first engagement surface;
a seal element that protrudes above the second engagement surface and extends about a periphery of the second engagement surface, wherein a height of a tip of the seal element above the second engagement surface is greater than a depth of the tapered groove below the first engagement surface, wherein the seal element is disposed in the tapered groove in the closed position; and
a latch having a first portion attached to one of the first and second shells, wherein the latch is operative to engage the other of the first and second shells to secure the shells in the closed position.

2. The apparatus of claim 1, further comprising:
a tongue formed on the second engagement surface and extending about the periphery of the second engagement surface, wherein the seal element is disposed over at least a portion of the tongue.

3. (canceled)

4. The apparatus of claim 1, wherein the tapered groove includes first and second slanting sidewalls, wherein an included angle between the first and second slanting sidewalls is an acute angle.

5. (canceled)

6. The apparatus of claim 4, wherein the tapered groove further comprises a bottom surface disposed between the first and second slanting sidewalls.

7. The apparatus of claim 6, wherein a tip of the seal element has a width that is greater than a width of the bottom surface of the groove.

8. The apparatus of claim 6, wherein the tip of the seal element comprises:
a rounded bulb portion.

9. The apparatus of claim 6, wherein the seal element further comprises first and second side surfaces, extending between a base of the seal and the tip, wherein the side surfaces are slanted such that an included angle between the side surfaces is acute.

10. The apparatus of claim 9, wherein at least one of the first and second side surfaces of the seal element comprises at least one lip.

11. The apparatus of claim 10, wherein a width of the lip measured across the cross-section of the seal element is greater that a corresponding width of the groove.

12. The apparatus of claim 9, wherein the seal element and the groove are sized such that in the closed position:
the tip of the seal element is axially compressed; and
at least one of the first and second side surfaces of the seal element is at least partially compressed in a direction normal to its surface.

13. (canceled)

14. (canceled)

15. The apparatus of claim 1, wherein the first portion of the latch comprises:
a spring loaded pawl attached to one of the first and second shells, wherein the pawl is operative to engage a detent on the other of the first and second shells.

16. The apparatus of claim 15, wherein moving the shells from the open position to the closed position engages the spring loaded pawl with the detent.

17. The apparatus of claim 1, wherein the hinge member and the latch are disposed outside of the peripheries of the engagement surfaces.

18. A pneumatic carrier for use in a pneumatic tube transport system, comprising:
a first shell having a first engagement surface including a tapered groove extending about a periphery thereof;
a second shell having a second engagement surface including a tongue extending about a periphery thereof;
a sealing element disposed over and attached to an outside surface of the protruding tongue;
a hinge member coupled to the first shell and the second shell and permitting movement between a closed position and an open position, wherein the sealing element and the tongue are disposed in the tapered groove in the closed position and wherein at least first and second separate portions of the seal element are compressed between first and second sets of mating surfaces of the tapered groove and the tongue, wherein the first and second sets of mating surfaces are transverse; and
a latch having a first portion attached to one of the first and second shells, wherein the latch is operative to engage the other of the first and second shells to secure the shells in the closed position

19. The apparatus of claim 18, wherein the latch comprises:
a spring loaded pawl attached to one of the first and second shells; and
a detent formed into the other of the first and second shells, wherein the detent receives the pawl as the shells move from the open position to the closed position.

20. The apparatus of claim 18, wherein the first portion of the seal is compressed along a first line of compression and the second portion of the seal is compressed along a second line of compression, wherein the first and second lines of compression are transverse.

21. The apparatus of claim 18, wherein the first set of mating surfaces comprises:
a tip surface of the tongue; and
a bottom surface of the tapered groove.

22. The apparatus of claim 21, wherein the tip surface and the bottom surface are substantially parallel in the closed position.

23. The apparatus of claim 21, wherein the second set of mating surfaces comprises:
a side surface of the tapered groove; and
a side surface of the tongue.

24. The apparatus of claim 23, wherein the side surfaces of the tapered groove and the tongue are substantially parallel in the closed position.

25.-29. (canceled)

30. The apparatus of claim 18, wherein the sealing element includes a tip and first and second sides, wherein at least a first side further includes:
at least one lip.

31. (canceled)

32. A pneumatic carrier for use in a pneumatic tube transport system, comprising:
a first shell having a first engagement surface including a tapered groove extending about a periphery thereof;
a second shell having a second engagement surface including a tongue extending about a periphery thereof, wherein a sealing element is disposed over and attached to an outside surface of the tongue;
a hinge member coupled to the first shell and the second shell and permitting movement between a closed position and an open position, wherein the sealing element and the tongue are disposed in the tapered groove in the closed position; and
a latch including:
a biased pawl member attached to one of the first and second shells; and
a detent formed into the other of the first and second shells, wherein the detent receives the pawl as the shells move from the open position to the closed position and wherein upon the receiving the pawl, the seal element forms a fluid tight seal around the peripheries of the engagement surfaces.

33. The apparatus of claim 32, wherein biased pawl member comprises:
a sliding element; and
a spring, wherein the sliding element compresses the spring when the sliding element moves from a first position to a second position.

34. The apparatus of claim 32, wherein the detent further comprises:
a ramp surface, wherein a tip of the biased pawl member engages the ramp surface as the shells move from the open position to the closed position, wherein the tip of the biased pawl member is biased into the detent when the shells reach the closed position.

35.-38. (canceled)
